(19) United States
(12) Patent Application Publication
(10) Pub. No.: US 2012/0137377 A1
(43) Pub. Date: May 31, 2012

(54) METHOD AND SYSTEM FOR SAFEGUARDING DIGITAL OBJECTS CONSISTING OF DIGITAL ASSETS

(75) Inventors: Stuart Antony Green, Sheffield (GB); Elizabeth Susan Stone, Sheffield (GB); Gordon Doran, Walnut Creek, CA (US); Gareth Simpson, Burbank, CA (US)

(73) Assignee: ZOO Digital Limited, a Limited Company, Sheffield (GB)

(21) Appl. No.: 12/956,984

(22) Filed: Nov. 30, 2010

(51) Int. Cl. G06F 21/24

(52) U.S. Cl. 726/30

(57) ABSTRACT

Provided is a system and method for safeguarding digital objects consisting of digital assets. The system includes a unique identifier in each digital asset and a database with a record of each unique identifier, the database further structured and arranged to correlate at least two digital assets as distinctly related. A client is in communication with the database. The client is adapted to receive a subset of the digital assets and analyze each digital asset to determine the unique identifier embedded therein. The client is further adapted to query the database with the determined unique identifier to validate each digital asset, the validation further including confirmation of distinctly related digital asset received. An associated method is also provided.

### FIELD OF THE INVENTION

The present invention relates generally to systems and methods for managing digital media, and more specifically to systems and methods for safeguarding digital objects consisting of digital assets.

### BACKGROUND

Prior to the advent of computers and their refinement for incorporation into nearly all aspects of normal life, assets and objects such as paintings, photographs, and analog recordings of music, movies, theater and television shows were very identifiable assets.

Although copying could be achieved either by manual or automated methods, it was in many cases difficult to provide a copy that was truly indistinguishable from the original. Further, assets were generally integrated, as in a movie reel providing both the visual and audio track. In other cases, given the relatively few number of copies it was a relatively simple task to track which assets were truly related to one another.

The digital age of information storage and transmission has revolutionized many things, including the ability to duplicate and disseminate information. Digital media, as opposed to analog media, are usually compilations of electronic data organized in accordance with a methodology that permits both a structured encoding of information as well as the retrieval of information such as for example the playback of a song, movie or show.

Digital media frequently consists of various different digital assets such as audio, video, text, image or other files that can be created, altered, transformed, referred to or otherwise manipulated by digital information processing machines such as computers.

Digital assets are typically recorded on computer devices in the form of files, which in turn are stored within the structure of a file system. As digital files are generally well understood to be structured for conveniently storing, processing and distributing information, they lend a certain ease to the transfer of digital assets. For example, a digital audio track may be recorded using the MP3 format and stored in a file named song.mp3, or an image may be recorded in the JPEG format and stored in a file named image.jpg.

Files such as image.jpg and song.mp3 can easily be duplicated on one or many different systems, or transferred between computer systems. Typically when a digital file is copied there is little if any perceptible difference between the original and the copy, save perhaps for the date and time stamp.

In addition to the data recording the “essence” of the asset, such as the sequence of bits in song.mp3 that when played on a compliant MP3 device provide the audible reproduction of the song, digital assets typically also have accompanying metadata. Metadata is loosely defined as data about data.

Metadata is a concept that applies mainly to electronically archived or presented data and is generally used to describe the; a) definition, b) structure and c) administration of data files in order to assist in the further use of the data files. For example, song.mp3 may include metadata specifying the artist, the title, the publisher and so on that may be displayed visually by an MP3 player.

When metadata exists it is very important to be able to associate it with the corresponding essence information for a digital asset. For this reason the metadata is often incorporated within a file that stores the essence. For example, an MP3 file incorporates a ‘header’ that will typically be used to store metadata such as the artist, title and publisher. Consequently, when an MP3 file is copied from one computer system to another, the copy will retain the metadata so that the player can correctly display the title of the track and other information when it is played.

With respect to digital media, it is not uncommon for files to be very large, especially in the case of video. Generally the higher the quality of the video the larger the file. When a digital file is produced from an analog original, such as through the digitization of a classic movie film, the size of the digital file may be very large as the digital encoding operation often captures a broad spectrum of elements.

In many cases, some if not many of these elements may be of little concern, however to preserve the option to decide what may or may not be desired for a later date, and/or to permit greater flexibility in how the digital version may later be used, the digitization is typically performed so as to capture as many elements as possible. Indeed unlike the more common DVD optical disc providing a movie for a consumer's viewing pleasure, it is not uncommon for such files to be so large as to require their own dedicated storage devices that have capacities that are well in excess of common optical disc capacities.

Companies involved in professional digital media production will typically store and work with enormous numbers of large digital asset files. The majority of such files are intermediaries, that is, they are components that are used in turn to create packages that are delivered or sold to customers.

For example, a film studio may create a master digital video file and digital audio recording either directly from contemporary production or from the digitization of an analog masterpiece and desire to commercialize the production on DVD optical disc. To create such a product typically requires many constituent assets to be combined and “authored”, in an authoring process, in order to yield a collection of digital asset files that are consistent with the DVD-Video format.

Typically the commercialized digital media may well include one or more video files, which are in turn obtained by compressing master video data into the MPEG2 format, the associated audio files for each such video file (which may be provided in multiple languages, requiring a separate audio file for each language), the associated subtitle files, closed caption files, graphical files containing on-screen menus, and so on.

The creation of a DVD-Video disc may involve many parties, for example one company/operator may receive a master video file and apply a compression process to produce an MPEG2 video file, another company/operator may do the same for the audio files, another company/operator may design and create the menu files, another company/operator may check the individual assets, and so on. Consequently, many of these intermediate files may be copied by many operators to multiple locations on different workstations and file systems and across different organizations.

Due to the size of many of these files, they are not commonly accessed as shared objects through a centralized database. More specifically, the time for network transfer of complete video files, especially over external networks such as the Internet, is so significant that for the professional environment especially, decentralization of copies is taken to be necessary.

In addition, as there are commonly many intermediate files and many different parties, metadata is often very important and maintained in an even greater quantity. For example, a digital audio recording may have associated metadata to record information such as: the recording engineer, the date and time of the recording, the settings of the mixing desk used to create this track, the instrumentation, details of the microphones and other recording devices used, etc.

Moreover, the metadata itself for any one digital asset can itself become quite voluminous. With respect to the metadata for professional digital asset data, there are in general three common approaches currently in use for associating assets and their metadata—embedding, companion file, and media asset management—yet each is subject to problematic issues, as set forth below.

Embedding—with embedding the metadata is incorporated into the digital asset file itself. This is certainly a robust approach that definitively associates the metadata with the corresponding digital data file. In some situations, the size of the metadata itself can be so great that the aggregate size of the combined file (metadata and asset essence data) is unacceptably large. For example, the metadata for an MPEG2 file created for the purposes of authoring a DVD-Video disc may become too large to fit on the disc, and in any case that metadata would be superfluous for the final product on the final disc. As consumers are accustomed to “extras” such as out-takes, commentary, alternative endings, games, etc. . . . including the metadata would also be undesirable as usable commercial space would be wasted.

A further consideration is that intermediate digital asset files may become modified (intentionally or otherwise) during the course of certain types of processing that could result in the metadata being stripped out. For example, for an MPEG2 file any metadata would be represented using the “user data” fields supported by that format. Since “user data” is an application-specific attribute, an application that processes a file may simply remove any user data or replace those fields with its own information.

One further shortcoming of embedded metadata is that intermediate files are usually considered to be read-only copies, and many such copies may exist at multiple locations, therefore the metadata cannot easily be updated in a way that will preserve additions to the metadata across all locations. This is a consequence of the fact that intermediate digital asset files are communicated using digital copies rather than by a centralized approach.

In short, embedding may well permit a tight association of the metadata with its related digital data, but file size can be highly undesirable, uncorrelated change of the metadata can occur for one copy but not another, and the user of a file has no basis by which to be assured that he or she has the most recent or correct copy of the file.

Companion File—with a companion file the metadata is simply stored in a separate file. For example, the file song.mp3 may have an associated metadata file named, say, song.dat. The idea is of course that both files (the digital asset and the metadata) are supplied together and always maintained as a single unit. Because the metadata file is separate, unnecessary enlargement of the digital asset file is avoided, and the metadata will be unaffected by any processing performed on the digital asset file.

A disadvantage of this approach is that it is very difficult to ensure that the association between the pair of files is maintained. Simply put, it is easy for the digital asset file and its companion metadata file to become separated. The separation of the metadata file would be bad enough, but potentially worse would be where, intentionally or unintentionally, the digital asset files and their companion files become matched incorrectly.

Media Asset Management—with media asset management typically the digital asset file (or more usually a reference to that file stored on a file system) and its metadata are stored together in a centralized management system. Though perhaps useful for archiving of either the finished or source digital assets, the centralized requirement for both the asset file and the metadata file make them unmanageable for intermediate asset files. As noted above, the size of the asset files, and the need for local copies and reproduction of copies for each company or operator tasked to work with the asset are issues that drive towards decentralization and away from centralized media asset management systems simply to permit commercial operation.

Moreover, especially for the professional production environment it is essential, though also problematic, to ensure that a company and or operators tasked to work on a digital media project are supplied with and generate the correct digital asset files. Moreover, current issues and questions such as, is this the right asset file, are there other versions of the asset file that are more current, has this file been inadvertently modified, have the rights been cleared and/or approval secured for use of the file, is this file compatible with another asset file, and others are critically important to providing proper and timely professional services relating to digital media, but which are also unaddressed by current systems.

It is to innovations related to this subject matter that the claimed invention is generally directed.

### SUMMARY

This invention provides a system and method for safeguarding digital objects consisting of digital assets.

In particular, and by way of example only, according to one embodiment of the present invention, provided is a method of safeguarding digital objects consisting of digital assets including: receiving a subset of the digital assets, each digital asset of the digital object having a unique identifier embedded therein; analyzing each received digital asset to determine each unique identifier; and querying a database with each determined unique identifier to confirm a proper relationship as between at least a first received digital asset and a second digital asset, and validate or invalidate the subset of digital assets.

In another embodiment, provided is a method of safeguarding digital objects consisting of digital assets, including: embedding a unique identifier in each digital asset; entering each unique identifier in a database, the database further structured and arranged to correlate at least two assets as distinctly related, the database further including reference to related metadata regarding each identified asset, the metadata further identifying a relationship between derivative digital assets; and applying a removable impairer to at least one digital asset, the impairer structured and arranged for removal upon proper authentication by an authorized party.

In yet another embodiment, provided is a method of safeguarding digital objects consisting of digital assets, including: embedding a unique identifier in each digital asset; entering each unique identifier in a database, the database further structured and arranged to correlate at least two assets as distinctly related; selecting at least a subset of the digital assets for delivery to a third party; receiving, by the third party, the selected subset of digital assets; analyzing each digital asset to determine the unique identifier embedded therein; and querying the database with the determined unique identifiers to validate each digital asset, the validating further including confirming receipt of distinctly related assets.

Further still, in yet another embodiment, provided is a system of safeguarding digital objects consisting of digital assets, including: a unique identifier in each digital asset; a database with record of each unique identifier, the database further structured and arranged to correlate at least two assets as distinctly related; and a client in communication with the database, the client adapted to: receive a subset of digital assets; analyze each digital asset to determine the unique identifier embedded therein; query the database with the determined unique identifier to validate each digital asset, the validation further including confirmation of distinctly related assets received.

### BRIEF DESCRIPTION OF THE DRAWINGS

At least one system and method of data storage will be described, by way of example only in the detailed description below with particular reference to the accompanying drawings in which like numerals refer to like elements, and:

FIG. 1 is a high level block diagram of a system for safeguarding digital objects consisting of digital assets in accordance with at least one embodiment;

FIG. 2 is a conceptual illustration of a unique identifier embedded within a video stream represented by a digital asset in accordance with at least one embodiment;

FIG. 3 is a conceptual illustration of a removable impairer as applied to the video stream represented by a digital asset as shown in FIG. 2, in accordance with at least one embodiment;

FIG. 4 is a conceptual illustration of a derivative digital asset resulting from the removal of the impairer as shown in FIG. 3, in accordance with at least one embodiment;

FIG. 5 is a high level flow diagram illustrating a method for safeguarding digital objects consisting of digital assets in accordance with at least one embodiment;

FIG. 6 is a table illustrating the database records in accordance with the method of FIG. 5, in accordance with at least one embodiment;

FIG. 7 is a map depicting the derivative relationships and closely related relationships between digital assets as shown in the table of FIG. 6, in accordance with at least one embodiment, and

FIG. 8 is a block diagram of a computer system for a client or a database in accordance with at least one embodiment.

### DETAILED DESCRIPTION

Before proceeding with the detailed description, it is to be appreciated that the present teaching is by way of example only and not by limitation. The concepts herein are not limited to use or application with a specific system or method of safeguarding digital data, or, specifically, digital objects consisting of digital assets. Thus although the instrumentalities described herein are for the convenience of explanation shown and described with respect to exemplary embodiments, it will be understood and appreciated that the principles herein may be applied equally in other types of systems and methods of safeguarding digital data.

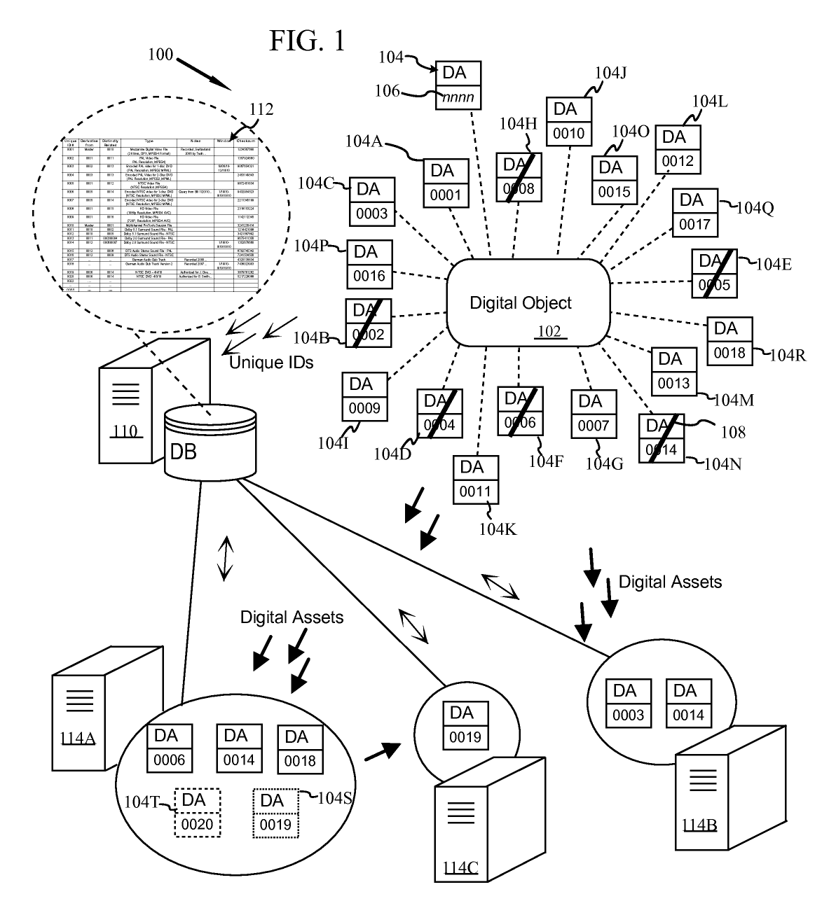

Turning now to the drawings, and more specifically FIG. 1, illustrated is a high level block diagram of a system for safeguarding digital objects (“SSDO”) 100 in accordance with at least one embodiment. As is further described in detail below, stated generally for at least one embodiment, the SSDO 100 is structured and arranged to provide an environment for safeguarding digital objects 102 consisting of a plurality digital assets 104, of which initial digital assets 104A˜104R are exemplary.

As used herein a digital object 102 is understood and appreciated to be a movie, show, production or other collective work of associated digital assets 104 such as, but not limited to image files, video files, text files, audio files, and/or other multimedia files. By themselves, these digital assets 104 are not necessarily conclusively identifiable. A list of file names may help suggest what each file is based on file extension, e.g., .mov, .mp3, .wav, .jpg but file extensions can be changed or removed. The root of the file name may help, but names such as PatentCaper.mov and PatentCaper2.mov are typically only meaningful to the original naming party.

By looking at a video it may be possible to tell what film or production it is related to—but that identification may fall short of knowing which ending or alternative scenes are involved. Likewise a listener may be able to identify a soundtrack in his or her native language, but definitive identification can be challenging. Subtle differences between different versions or even related files may be difficult to distinguish by inspection alone. Further still, any inter-relations between the digital assets 104 may not be clear.

As shown, each digital asset 104 has a unique identifier 106 embedded therein. The unique identifier 106 is robust so that it will persist through various operations and/or transformations performed with a digital asset 104. In addition, in at least one embodiment at least a subset of digital assets 104 have a removable impairer, represented as tick line 108, applied or embedded thereto. As is set forth in greater detail below, the removable impairer 108 is structured and arranged to impair the digital asset 104 so that it is unstable if not unusable unless or until the impairer 108 is removed. It is further understood that for any given digital asset 104, the unique identifier 106 is distinct from the removable impairer 108.

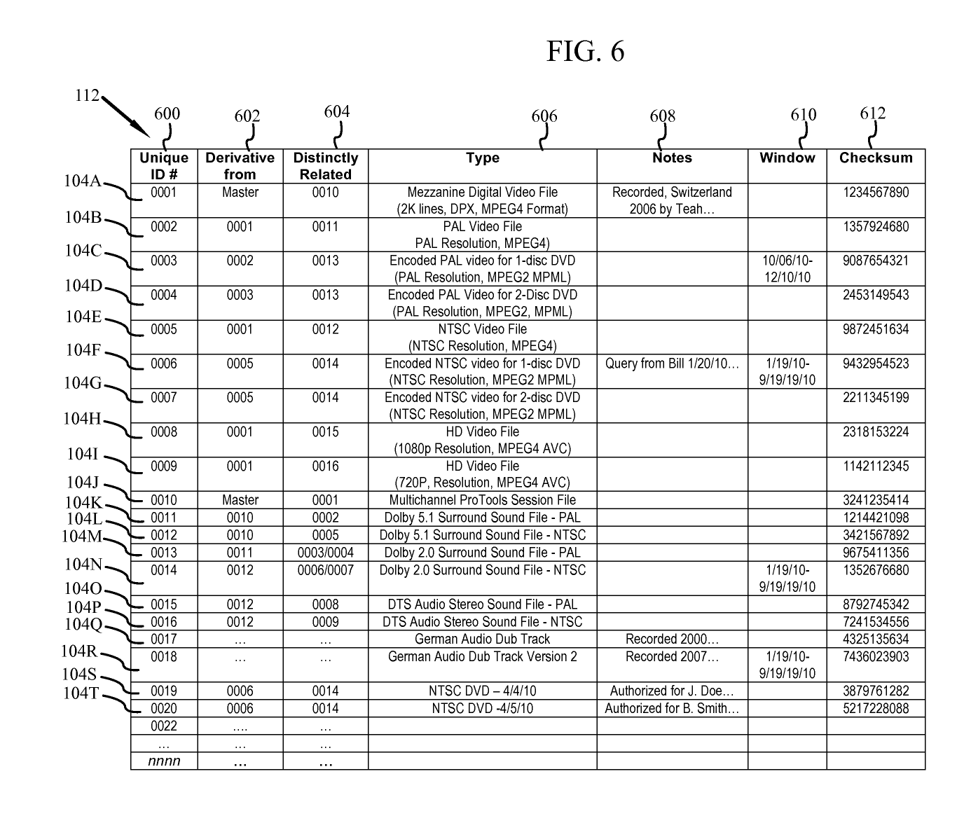

SSDO 100 further includes a database 110 that is structured and arranged to record each unique identifier 106 and thereby identify each respective digital asset 104. Based on a queried unique identifier 106, the database 110 can also provide the associated metadata relevant for a specific digital asset 104. For ease of illustration and discussion, the database information is further illustrated as a table 112 (shown in greater detail in FIG. 6).

The database 110 may be employed on a computer having typical components such as at least one central processor (“CPU”), memory, storage devices and input and output devices adapted to perform as database 110. During operation the information represented by table 112, or at least a portion thereof, may be maintained in active memory for enhanced speed and efficiency. In addition, the database 110 may be operated as a networked database utilizing distributed resources.

It is understood and appreciated that for at least one embodiment the digital assets 104 themselves are not held and/or maintained by the same database 110 containing the unique identifiers 106. Moreover, SSDO 100 advantageously permits the decentralized nature and/or reference of digital assets 104 while centralizing metadata regarding the digital assets 104. In addition, for at least one embodiment the database 110 is structured and arranged to correlate at least two digital assets 104 as properly related.

More specifically, for at least one embodiment a proper relationship is understood to be a distinctly related relationship, such as a source file and a derivative file. The clear and unequivocal identification of source and derivative may be highly desirable and/or beneficial in the professional environment of authoring audiovisual products. A distinctly related relationship also includes files clearly and unambiguously associated for operating purposes such as country related digital assets, i.e., NTSC audio and video files as opposed to PAL audio and video files. SSDO 100 advantageously permits distinct relationships to be known and recognized accordingly. Moreover, as used herein a distinct relationship for the purposes of history, e.g., file creation and/or modification, is understood and appreciated to be the relationship of source file and derivative file, and for purposes of interaction are understood and appreciated to be those files that are mutually dependent upon one another. In this way, according to at least one embodiment, any party legitimately accessing the assets, who rightly also has access SSDO 100, can determine categorically that they are accessing not only the correct kinds of assets but also the correct versions thereof at any particular point in time.

Moreover, database 110 as represented by table 112 identifies the unique identifiers 106 for each digital asset 104, relates at least some assets to other assets, and can provide information about the type of digital asset 104, who created it, who has worked on it, who is authorized to work on it, the time period of authorization and other such information regarding the digital asset 104. With respect to each digital asset 104, the “essence” data is that data which is the core of the asset—the digital information representing the sound wave, image, etc. In the broadest sense other information regarding the digital asset 104 may therefore be considered metadata. Of course, some types of digital assets 104, such as image files, may by default inherently contain some information such as copyright notice, the type of camera used, exposure, etc. . . . which may be considered metadata.

Although metadata may well be broadly viewed as data about data, it is also understood and appreciated that all data is not necessarily equal as some data, e.g., the unique identifiers 106 have very specific importance. SSDO 100 advantageously uses the unique identifier 106 associated with each digital asset 104 to correlate additional information stored separately from each digital asset 104. With respect to SSDO 100, the metadata of interest is generally understood and appreciated to be that data which is stored separately from the digital assets 104. Further, within the context of metadata, some elements of data, such as the unique identifiers 106 are appreciated to have distinct relevance.

As the database 110, and more specifically the table 112 of information is maintained separately from each asset, the information is not subject to inadvertent change, loss, separation or erroneous attachment. In addition, information transactions with the database 110 are manageable over network connections, permitting such exchanges to be substantially automated processes occurring in about real time.

As is further shown in FIG. 1, clients 114, of which clients 114A˜114C are exemplary, receive subsets of digital assets 104. These subsets may be provided by the parent entity owning, holding or otherwise responsible for the digital object 102, or from other third parties who have one or more digital assets 104, such as client 114C receiving digital asset 104T from client 114A.

Clients 114 may be established by computer systems having at least one processing unit (“CPU”), at least one memory storage device and input and output devices appropriately coupled to the CPU. The CPU is operative to adapt the client 114 as a component of SSDO 100 to safeguard the digital object 102.

Specifically, the clients 114 are in communication with the database 110. Further the clients are adapted to receive at least one digital asset 104 and analyze the received digital asset 104 to determine the unique identifier 106 embedded therein. The clients 114 are further operable to query the database 110 with the determined unique identifier 106 to validate the digital asset 104.

In varying embodiments, the validation may take alternative forms. Specifically validation can be, but is not limited to, confirmation that the client 114 has received the correct type of digital asset(s) 104, the correct versions of the digital asset(s) 104, that the client 114 is attempting to work on the asset(s) 104 within an approved time period, that there is a proper relationship between digital assets 104, that the digital asset(s) 104 received have been intentionally or unintentionally modified, and or combinations thereof.

With respect to the unique identifier 106 of each digital asset 104, it is appreciated that each digital asset 104 is typically arranged to present a stream of data organized as a series of blocks, clips, cells or other definable elements. Although it is of course realized that each type of digital asset, e.g., audio, video, text, etc. . . . has different formats, the underlying principle of the unique identifier 106 is the same.

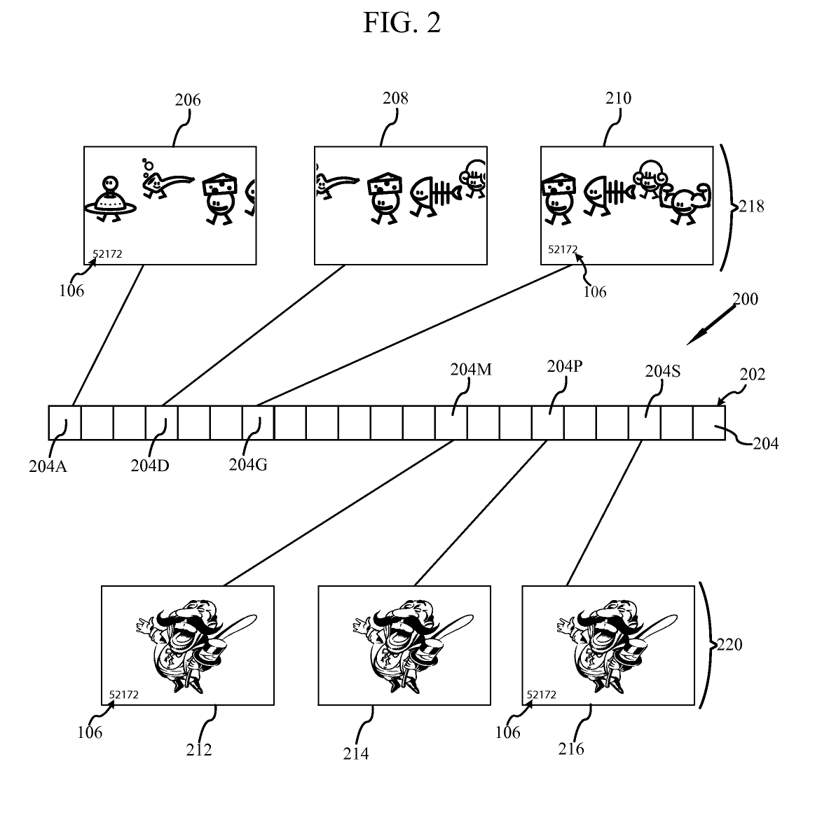

FIG. 2 conceptually illustrates a portion of a digital asset 200 correlating to a digital asset 104 shown in FIG. 1. As shown, digital asset 200 provides a video stream 202 comprised of a series of elements 204. Exemplary video images are shown to correspond to certain elements 204. Specifically, image 206 corresponds to element 204A, image 208 corresponds to element 204D, image 210 corresponds to element 204G, image 212 corresponds to element 204M, image 214 corresponds to element 204P, and image 216 corresponds to element 204S. Images 206˜210 represent a marching critters video sequence 218 and images 212˜216 represent an opera singer video sequence 220.

The unique identifier 106, conceptually illustrated as the number sequence “52172” is shown to appear in every sixth image, e.g., images 206, 210, 212, and 216. In alternative embodiments the repeating frequency may be set at a different interval, including every image, or established to be generally random. It is understood and appreciated that in varying embodiments the unique identifier 106 is readily apparent to a user in some embodiments, while being discrete and/or otherwise generally imperceptible to a user in others.

It is also understood that the unique identifier 106 is not limited strictly to a numerical ID. Although the exemplary number has been chosen for ease of illustration and description, the unique identifier 106 may consist of any combination of numbers, characters, symbols or other elements such as but not limited to binary elements, patterns of color shifting, digital watermarks, etc. . . . sufficient to provide unique identification.

As the unique identifier 106 is shown to be present in multiple images, it is understood and appreciated that the unique identifier 106 is robust. Indeed, it is highly likely that the unique identifier 106 shown as “52172” will persist through events such as digital asset 104 compression, truncation, transformation, corruption, conversion and or combinations thereof. For example, if the marching critters sequence 218 or the opera singer sequence 220 is removed, edited or otherwise altered, the altered sequence will still contain the unique identifier 106 as will the remaining portion of the video stream 200.

The insertion of the unique identifier 106 into each digital asset 104 may be accomplished by various methods. By way of example and illustration, digital asset 104 represented by video stream 202 may be considered an MPEG2 video stream. MPEG2 is an audio/video file format designed to support digital transmission of broadcast quality video at rates of between about 4˜9 Mbps. This format, which is an ISO standard (i.e., ISO/IEC 13818) is the video carrier used by the DVD-Video specification.

The MPEG2 format supports optional fields known as “User Data” which provide an opportunity to inject application-specific data into an MPEG2 elementary stream. User data can be inserted on three different layers of the seven layer MPEG2 stream structure: a) the sequence level, b) the group of pictures (GOP) level, and/or c) the picture data level.

Applications that process MPEG2 data do not need to be able to understand data encapsulated in this way, but they generally are able to preserve the data. Therefore, the User Data fields are at least one way to incorporate a unique identifier into an MPEG2 video stream as the User Data fields, carried throughout the stream, will carry the unique identifier 106 throughout the stream 202.

Inserting a unique identifier 106 into a digital asset 104 providing an MPEG2 video, can be achieved by processing an MPEG2 stream, identifying a Sequence Header at the sequence level, GOP structures at the GOP level, and Picture structures at the picture data level, and in occurrences of each inserting a User Data field containing the designated unique identifier 106, e.g., “52172.”

Moreover, the following exemplary command loop may be applied in at least one embodiment to encode a unique identifier 106 of “52172” in an appropriate MPEG2 digital asset 104:

For each sequence:

Insert a User Data entry for the ID
For each GOP

Insert a User Data entry for the ID
For each picture

Insert a User Data entry for the ID

In at least one alternative embodiment, data hiding methods, such as digital watermarking, may be utilized to embed the unique identifier 106. Generally, and with respect to video assets, these methods operate by making subtle changes to certain pixels in certain frames of the video in such a way that the changes are not generally perceptible, yet readily present for detection and analysis by software that is aware of the data hiding scheme in use. Other digital watermarking techniques may embed readily apparent, visible watermarks in certain frames of the video. Applicant's U.S. Pat. No. 7,783,888, entitled “Watermarking In An Audiovisual Product” and incorporated herein by references, describes various ways for watermark characters to be recorded in video or audio objects in a recorded audiovisual product, which may be suitable for adaptation in various embodiments of the present invention.

Further, in at least one embodiment, the unique identifier 106 is encoded by at least two methodologies. Such a combination of efforts may advantageously increase the robust nature of the unique identifier 106.

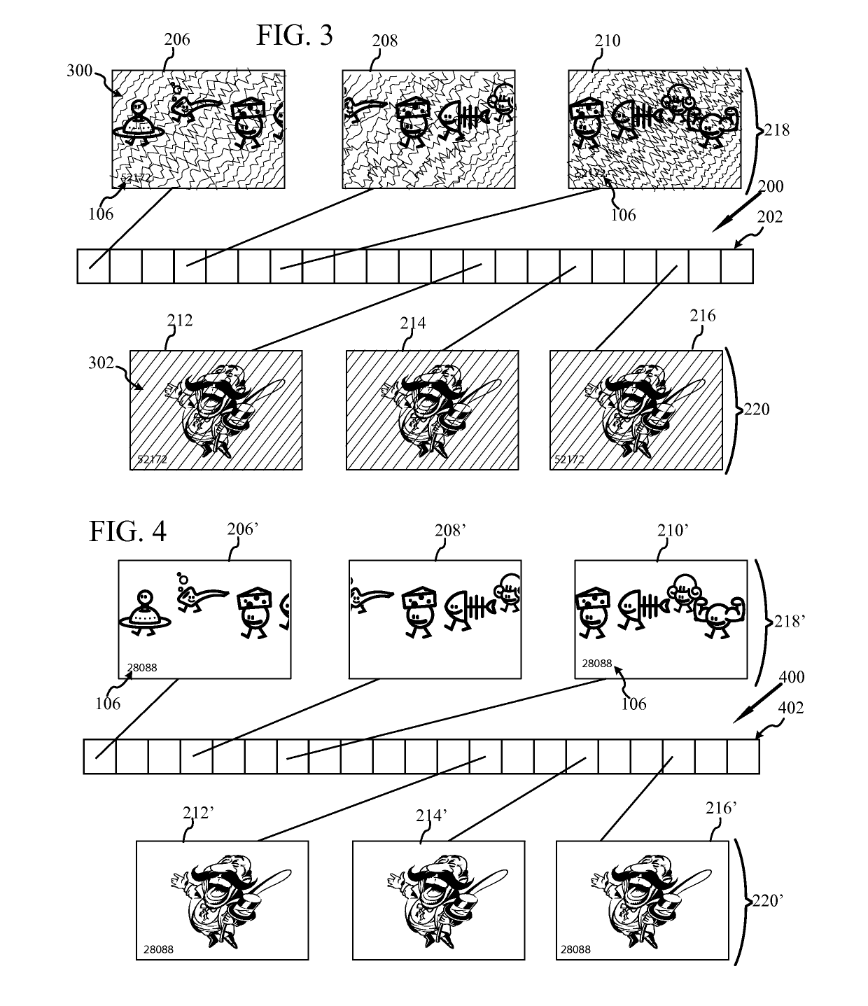

FIG. 3 conceptually illustrates the digital asset 200 shown in FIG. 2 as video stream 202 with a removable impairer 108. With respect to the marching critters sequence 218 the removable impairer 108 is illustrated to be a varying impairer 300, and with respect to the opera singer sequence 220 the removable impairer 108 is illustrated as a consistent impairer 302. The removable impairer 108 may be an element achieved by several options, including but not limited to, intentional offsetting of color or other image elements, simulating an analog distortion of the video signal, applying additional image material, bit manipulation of the digital information, and or combinations thereof.

Moreover, there are various methods by which a digital asset may be impaired to be unusable, yet restored to an unimpaired state by the application of a specific process. Of course, the removable impairer 108 could be achieved by applying an encryption program such as gzip, Pretty Good Privacy (PGP) or other such application. The removable impairer 108 may also be the scrambling of the digital data in accordance with a pre-defined, or otherwise reversible methodology.

However, in some embodiments there are advantages to performing the impairing step in such a way that the file appears to be a valid asset, for example, if the asset represents a video stream then it may be advantageous to impair such an asset so that the output is also a video stream that will playback in any compliant device. It also may be desirable to at least tell by sight or sound what the digital asset 104 is even in an impaired state.

More specifically an audio asset may have an unpleasant tone, cadence or warble imposed but still permitting identification of the contained language as English or French. Similarly, a video asset may still be perceived to be a movie, though jittery, inverted in color, visually pixilated, partially masked, or otherwise impaired. Much as a game of cricket or baseball could be watched through a peep hole in a fence, the experience and perception of the event is entirely different from the full scale perception of sitting in the stands, so too does the impairing diminish the experience and perception of the asset. In other words the impaired asset may be identifiable, but, for example, the quality, view-ability, listen-ability of the impaired asset is so distorted and otherwise unacceptable that the impaired asset is unsuitable for general purposes beyond mere identification.

With respect to such an example of a removable impairer 108, an MPEG 2 video asset is an appropriate example. MPEG2 uses a form of compression based on the Discreet Cosine Transformation (DCT) which processes 8×8 blocks of samples (ie. pixels) to generate corresponding 8×8 blocks of DCT coefficients. Each DCT coefficient indicates the amount of a particular horizontal or vertical frequency within the block.

DCT coefficient (0,0) is known as the DC coefficient and corresponds to the average sample value for the corresponding 8×8 block. A simple method of impairing an MPEG2 asset is to modify the DC coefficient in every block using the values returned by a Linear Congruential Generator (LCG) algorithm. The LCG algorithm has the property that, given an initial seed value, each successive value generated is deterministic based on the following recurrence relation:

Xₙ₊₁=(aXₙ+C)mod m

Moreover, in accordance with this equation, implementing a removable impairer 108 upon a digital asset 104 can be performed by processing each block in the MPEG2 stream in the order in which it appears and adding the next value of the LCG modulo N to the block's DC coefficient value (where N represents the range of DCT coefficient values in the stream).

For at least one embodiment, such removable impairment is applied in accordance with the following operation:

Initialize LCG X( ) with a seed value;
For each sequence:

For each block:

Extract the DC value
Calculate DC value + X( ) mod N
Replace DC with new value

This process is reversible by providing the same seed value to the LCG that was used at the time the impairment was applied, processing each block and subtracting the value of the sequence generator modulo N from the block's DC value. In accordance with at least one embodiment of SSDO 100, the removable impairer 108 is structured and arranged for removal only by authorized parties upon validation of a detected unique identifier 106.

Of course, removal of the impairer 108 results in a new digital asset 400 that is a derivative of the impaired digital asset 200, see FIG. 4. As is shown, the images 206′, 208′, 210′, 212′, 214′, and 216′, of the marching critters sequence 218′ and opera singer sequence 220′ are substantially the same as images 206, 208, 210, 212, 214, and 216, of the marching critters sequence 218 and opera singer sequence 220 shown in FIG. 3, save for the presence of the variable impairer 300 and constant impairer 302.

In at least one embodiment, the new digital asset 400 having digital stream 402 free of any impairer 108 is assigned a new unique identifier 106, i.e., “28088” as shown, that is recorded in the database 110 thereby noting the new digital asset 400 as related to digital object 102, and specifically a derivative asset based on digital asset 200.

As the new digital asset 400 was initially digital asset 300 with the removable impairer 108 removed, the former unique identifier 106 is adjusted to the new unique identifier. In varying embodiments, this adjustment may be achieved by simple replacement of all or some of the elements or by addition of new elements.

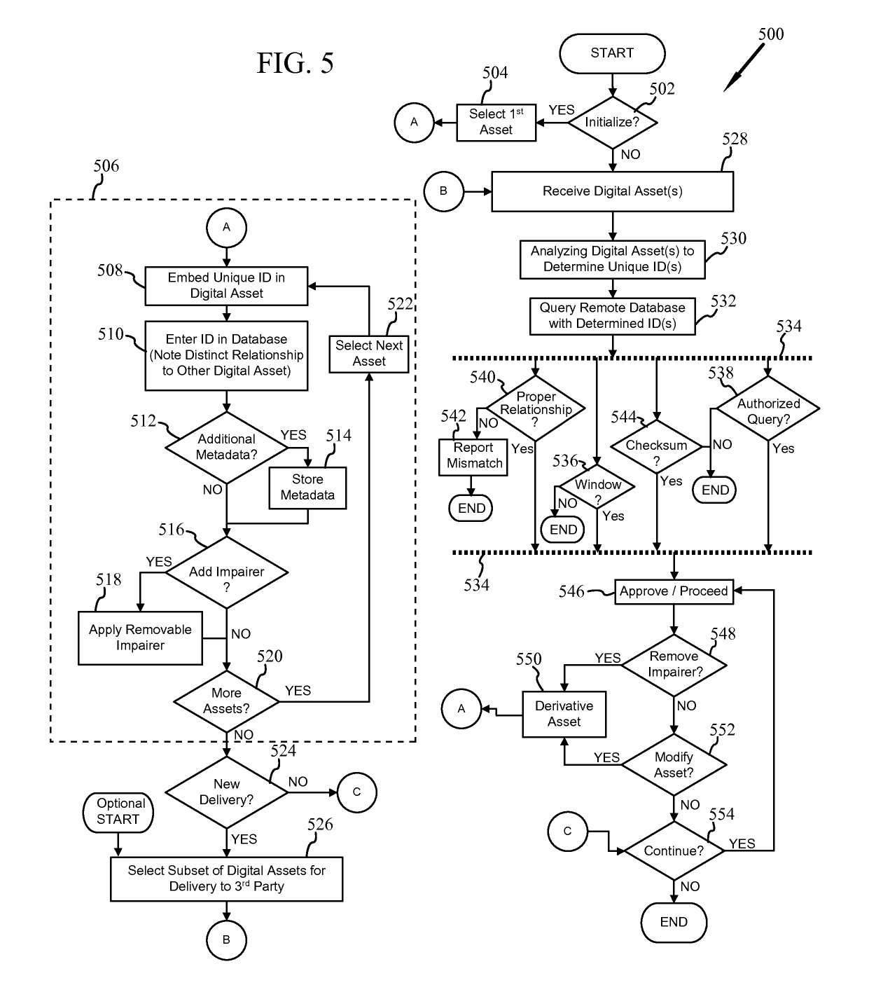

FIG. 5, in connection with FIGS. 1, 6 and 7 conceptually illustrates a high level flow diagram depicting at least one method 500 for the safeguarding of digital objects 102 consisting of digital assets 104. It will be appreciated that the described method need not be performed in the order in which it is herein described, but that this description is merely exemplary of one method for safeguarding of digital objects 102.

In general, the method 500 commences with a determination of whether an embodiment of SSDO 100 is to be initialized, decision 502. In other words, is digital object 102 and, more specifically, are the digital assets 104 known to the database 110?

When the SSDO 100 is being initialized, the answer is yes, and method 500 proceeds to select a first digital asset, block 504, and continues to processing loop 506, via reference A. The processing loop begins by embedding a unique identifier 106 in the digital asset 104 as described above, block 508. The unique identifier 106 is also entered in the database 110, block 510.

In at least one embodiment, the unique identifier 106 is obtained from the database 110. In at least one alternative embodiment the unique identifier 106 is obtained from an agent (not shown) that is in communication with the database 110. This agent may be an element of the database 110 or an element of another system, such as a client system 114 that is operating to initialize the digital assets 104. Further, in yet another embodiment, the unique identifier is determined relatively autonomously, such as by the application of an MD5 hash performed upon the digital asset and a variable such as the current date and time. MD5 is a widely used cryptographic hash function that is commonly used to check the integrity of files.

FIG. 6 presents an enlarged detail of the database 110 table 112 suggested by FIG. 1. As shown for this exemplary embodiment, table 112 provides a unique identifier field 600, a derivative from field 602, a distinctly related field 604, a type field 606, a notes field 608, a window field 610, and a checksum field 612.

The integrity of data, such as the digital asset 104 identified by unique identifier 106, can be confirmed by different methods. In at least one embodiment, such confirmation is implemented by a checksum. Simply stated, the digital asset 104 itself can be used as the input for a checksum function that will return, with high probability, a unique fixed-size value. A change, intentional or unintentional to the digital asset 104 will result in a different checksum value. As such, verification of integrity can be achieved by comparing the checksum of a received digital asset 104 against the checksum value recorded in the associated data field 612 as shown.

In varying embodiments there may be greater or fewer fields, and/or combined fields—the current selection having been determined for ease of illustration and discussion, and not by way of limitation. One or more of these fields may be collectively assumed to be the metadata. One or more of these fields may also reference a remote file system where additional metadata regarding a digital asset may be stored.

In at least one embodiment, the table 112 records the distinct relationship between digital assets. For example, as shown, the digital asset 104K having unique ID #0011 is a Dolby 5.1 surround sound file in PAL and is distinctly related to the digital asset 104B having the unique ID #0002 and noted as a PAL Video File in MPEG4. The ability to track this distinct relationship is advantageous. If a third party is tasked to develop a DVD for distribution in Europe where PAL format is the norm, it is highly advantageous for SSDO 100 to identify an errant delivery of an NTSC version file in place of the correct PAL file.

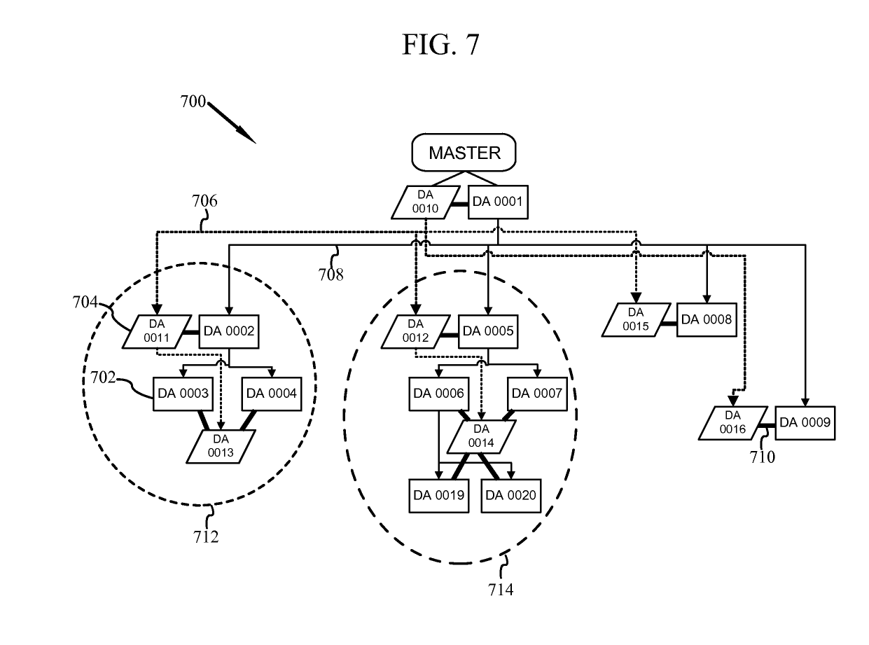

FIG. 7 presents a conceptual map 700 of the various relationships between a subset of the digital assets 104 as noted in the table 112 of FIG. 6. For ease of illustration and discussion, video digital assets are depicted in rectangles 702 while audio digital assets are depicted as trapezoids 704. The relationship of derivative audio digital assets is further illustrated with dotted arrow-lines 706 and the relationship of derivative video digital assets is further illustrated with solid arrow-lines 708. Moreover, the dotted-arrow lines 706 and the solid arrow-lines 708 illustrate the history based distinct relationships between audio digital assets and video digital assets respectively. Heavy solid lines 710 indicate mutual dependency based distinct relationships between digital assets.

More specifically, as indicated by the dotted circle 712 the digital assets 104 historically related and dependently related for a PAL production project are clearly and unmistakably identified and separated from the digital assets 104 historically related and dependently related for a NTSC production project as indicated by doted circle 714. Moreover, the database 110 and the resulting implied map 700 provides an advantageous ability to track and identify the digital assets 104 comprising the digital object 102.

Returning to method 500 in FIG. 5, decision 512 queries to see if additional metadata is to be added—i.e., a derived from, distinctly related, type, other, or window entry. If the answer is “Yes” the metadata is stored, block 514.

Method 500 continues with the query as to whether a removable impairer 108 is to be added, decision 516. Where the directive is “Yes” a removable impairer 108 is applied or otherwise embedded as discussed above, block 518. If more digital assets remain to be initialized, decision 520, the loop returns with the selection of the next asset, block 522 and the embedding of a unique identifier 106 therein, block 508. Loop 506 will repeat until all digital assets are initialized.

With the digital assets 104 so initialized, method 500 continues with a query as to whether a new delivery of digital assets is desired, decision 524. For the continuation of this example, it is assumed that the directive is “Yes”. This advances the method to the selection of a subset of digital assets 104 for the delivery to a third party, block 526. This is also an optional starting point for an embodiment of SSDO 100 where the digital assets 104 have been previously initialized. Block 526 branches to reference B.

Generally, the selection of the subset of digital assets 104 is based on at least one variable, such as but not limited to previous work with one or more digital assets 104, the relationship to another 3^{rd} party approved for work with one or more digital assets 104, available resources of the 3^{rd} party, priority for the project, and combinations thereof. Moreover, in at least one embodiment the variable is a defined work order.

As shown in FIG. 1 client 114A has been designated to receive digital assets 104F, 104N and 104R. Client 114B has been designated to receive digital assets 104C and 104N. With respect to table 112 as shown in FIG. 6, for client 114A these files are appreciated to be NTSC video, Dolby 2.0 NTSC audio and a German subtitle track. For client 114B these files are appreciated to be PAL video and Dolby 2.0 NTSC audio.

The subset of digital assets 104 is received, block 528. Specifically, in light of the initializing process each received digital asset 104 has a unique identifier 106 embedded therein. Each digital asset 104 is analyzed to determine the associated unique identifier 106 embedded therein, block 530.

With the unique identifier(s) 106 so determined, the remote database 110 is queried, block 532. In general, this query is to validate or invalidate the received subset of digital assets 104.

As previously noted, the validation may take alternative forms. Specifically validation can be, but is not limited to, confirmation that the client 114 has received the correct type of digital asset(s) 104, the correct versions of the digital asset(s) 104, that the client 114 is attempting to work on the asset(s) 104 within an approved time period, that there is a proper relationship between digital assets 104, that the digital asset(s) 104 received have been intentionally or unintentionally modified, and or combinations thereof.

Moreover, having a correct digital asset 104 may not be dependent upon having the most recent version of a digital asset 104. For example, in table 112 as shown in FIG. 6 digital asset 104Q is a German language dub track. Digital asset 104R is German language dub track version 2. Although version 2 may be a more recent creation, a change in the status of the actors providing the original may make it more desirable for a re-release DVD. Validation based strictly on most recent version or date would erroneously reject the original German dub track in favor of version 2. For a 3^{rd} party developer who is not fluent in German, this lack of correct identification would be significant. SSDO 100 and method 500 advantageously safeguard against such a situation.

With respect to FIG. 5, the validation process is illustrated between dotted parallel bars 534, indicating that options there between may be combined, and may also occur substantially concurrently.

In at least one embodiment, querying the database to validate each received digital asset 104 is permitted in a pre-set authorization window, decision 536. A query received within this window being validated, whereas a query received outside this window being invalidated. Further still, for each unique identifier 106 queried, the database may optionally record information about the querying party in the associated metadata.

As the database is optionally equipped with information regarding who an authorized 3^{rd} party is, the query can be immediately determined as authorized or unauthorized, decision 538. Indeed, the 3^{rd} party may generally be an authorized party for some digital assets 104 but not others. Where such a party receives the wrong digital asset 104, the error can be immediately identified and further action avoided by invalidating the received digital asset 104.

Further, in at least one embodiment, the method 500 determines a proper relationship as between at least a first received digital asset and a second digital asset, decision 540. In at least one embodiment, the proper relationship is a distinctly related relationship. For example, at least two distinctly related digital assets 104 are country related digital assets, e.g., digital assets 104F and 104N (NTSC video and audio files) as received by client 114A.

Whereas in the case of client 114B where the received files are not correctly related, e.g., digital assets 104C and 104N (PAL video and NTSC audio), the mismatch reported, block 542, and the received digital assets are invalidated. It is also noted that the second digital asset may be a previously received digital asset. In yet another embodiment, another 3rd party holds the second digital asset.

As noted, determining a proper relationship may in some cases be insufficient or an improper basis for proper verification. Indeed, where a work order specifies digital assets 104F (NTSC video for 1-disc DVD) and 104N (Dolby 2.0 Audio for NTSC), receipt of files 104G (NTSC video for 2-disc DVD) and 104N (Dolby 2.0 Audio for NTSC) which are also closely related, see map 700 in FIG. 7, would not permit validation of the digital assets 104.

Furthermore, the associated metadata provided for each digital asset 104 as identified by its unique identifier 106 permits variation in validation requirements from one digital asset 104 to another digital asset 104. For example, the database 110 can reflect the conditions of different work orders individually tuned based on the digital assets 104 involved, time frames and the intended third parties designated to perform the different services with the specified assets.

In varying embodiments, the validation process may also include the option of confirming the integrity of the digital asset 104 as received. For at least one embodiment this validation of integrity is to confirm that the digital asset 104 as received has not intentionally or unintentionally been altered since its associated record was added to the database 110. For at least one embodiment, this is a checksum verification, decision 544. As noted above, in at least one embodiment, table 112 as shown in FIG. 6 includes checksum value data in field 612. By performing a checksum computation for the digital asset 104 and comparing the resulting value with the checksum value recorded in the database 110 the integrity of the digital asset 104 is verified.

Moreover, in varying combinations for alternative embodiments, where the query: i) is performed within an authorized time window, decision 536; ii) is an authorized query, decision 538; iii) confirms a proper relationship, decision 540; and iv) returns confirmation of the checksum, decision 544, the digital assets are validated and the client is approved to proceed, block 546. Further, where the query is validated and the client approved, in at least one embodiment, the query further receives related metadata regarding the digital asset as identified by the database 110. Again as noted above, this metadata may be provided directly from the database 110, and or from at least one second remote file system, as referred to by the database 110.

The method 500 continues with a query to remove the impairer, decision 548, the removal of course being dependent upon validation as a correct digital asset 104. As discussed above with respect to FIGS. 3 and 4, removal of the impairer results in a derivative, block 550. As such method 500 branches to reference A, to embed a new unique identifier 106. With the new unique identifier 106 embedded in the digital asset 104 and recorded to the database 110, the method returns via branch C, with a query to continue, decision 554

Assuming that further work is desired, method 500 returns to approved condition of block 546. A user directed change to the digital asset results in yet another derivative digital asset. In at least one embodiment, the qualifier for such a user directed change is a “Save” command being issued to record an updated version of the digital asset, decision 552. The occurrence of a modification yet again leading to a derivative asset, block 544, and a new unique identifier embedded therein, via branch to reference A.

It should also be appreciated that a derivative digital asset need not be inferior to its parent asset. Indeed, an audio file digital asset 104 might be converted to .wav, .mp3, .m4b or other file type. Likewise a video file digital asset 104 might be converted to a .mpg, .mov, .wmv or other format. Moreover, a change in digital content or digital format type is sufficient basis for the generation of a derivative digital asset.

Returning again from the actions to embed a new unique identifier 106, via return branch C, method 500 again returns to the query of whether to continue or not, decision 554. Method 500 can continue so long as work with the digital asset 104 continues, and for each derivative asset created, block 544, the database 110 will receive notification. Moreover, as discussed above, in the professional environment of authoring audiovisual assets there are typically a large number of intermediate files representing variations of the digital assets 104. SSDO 100 and method 500 advantageously permits the tracking and identification of all such intermediate files.

With respect to FIG. 1, as shown and discussed above, client 114A has been provided with digital assets 104F, 104N and 104R. Following proper validation of the digital assets 104F, 104N and 104R and in accordance with a specified work order, client 114A proceeds to generate derivative digital assets 104S (authorized NTSC DVD for J. Doe) and 104T (Authorized NTSC DVD for B. Smith), shown initially in dotted relief. Client 114A may then deliver to client 114C the digital asset 104S.

Client 114C receives the digital asset 104S having the unique identifier 106, e.g., #0019, embedded therein. In accordance with method 500, client 114C analyzes the digital asset 104S to determine the unique identifier 106, e.g., #0019, and queries the database 110.

In a first instance, client 114C may query the database 110 with the determined unique identifier 106, e.g., #0019, to confirm a proper relationship as between at least a first received digital asset, e.g., digital asset 104S, and a second digital asset, e.g., digital asset 104N, and validate or invalidate the received digital asset 104S.

In a second instance, client 114 may query the database 110 with the determined unique identifier 106, e.g., #0019, to validate the received digital asset as a correct digital asset 104. In response to the validation as the correct digital asset, the removable impairer is removed from the digital asset 104S.

In accordance with the method 500, client 114C receives the digital asset 104S, analyzes digital asset 104S to determine the unique identifier 106, e.g., #0019, and queries the database 110.

To summarize generally, in at least one embodiment, SSDO 100 and method 500 permits the safeguarding of digital object 102 consisting of digital assets 104 by embedding a unique identifier 106 in each digital asset 104. The unique identifiers 106 are entered into a database 110, the database 110 further structured and arranged to correlate at least two digital assets 104 as distinctly related, e.g., digital asset 104F and digital asset 104N. From the pool of encoded digital assets, a subset of digital assets 104 are selected for delivery to a 3^{rd} party. The 3^{rd} party receives the selected subset of digital assets and analyzes each digital asset 104 to determine the unique identifier 106 embedded therein. The database 110 is then queried with the determined unique identifiers to validate each digital asset 104, the validation further including confirming receipt of distinctly related digital assets 104, e.g., digital asset 104F and digital asset 104N.

To summarize generally again, for an alternative embodiment, SSDO 100 and method 500 permits the safeguarding of digital object 102 consisting of digital assets 104 by embedding a unique identifier 106 in each digital asset 104. The unique identifiers 106 are entered into a database 110. A removable impairer 108 is also applied to each digital asset 104. From the pool of encoded digital assets, at least one digital asset 104 is selected for delivery to a 3^{rd} party. The 3^{rd} party receives the least one digital asset 104 and analyzes each digital asset 104 to determine the unique identifier 106 embedded therein. The database 110 is then queried with the determined unique identifiers to validate the at least one digital asset 104. In response to the proper validation, the removable impairer 108 is removed from the at least one digital asset 104.

Moreover, with respect to the above discussion and accompanying figures, it should be appreciated that SSDO 100 and method 500 in varying embodiments operatively permits the advantageous safeguarding of decentralized digital assets 104 collectively comprising a digital object 102.

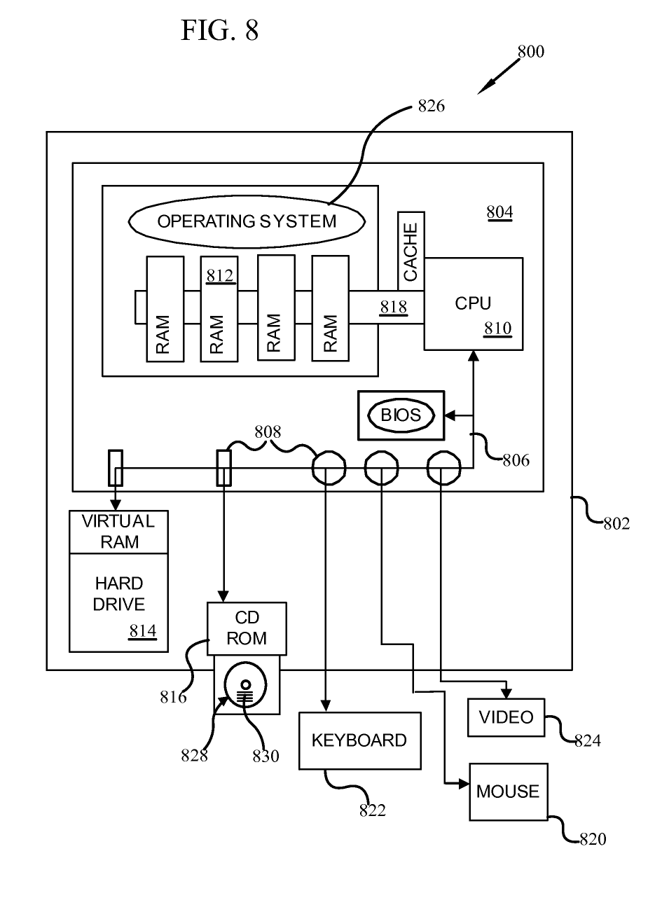

With respect to the above descriptions of SSDO 100 and method 500 it is understood and appreciated that the method may be rendered in a variety of different forms including code and instructions as may be used for different computer systems and environments. To expand upon the initial suggestion of computer implementation above with respect to the database 110 and clients 114 as shown in FIG. 1, FIG. 8 is a high level block diagram of an exemplary computer system 800, adaptable for operation either as the database 110 or a client 114. Computer system 800 has a case 802, enclosing a main board 804. The main board has a system bus 806, connection ports 808, a processing unit, such as Central Processing Unit (CPU) 810 and a memory storage device, such as main memory 812, hard drive 814 and CD/DVD ROM drive 816.

Memory bus 818 couples main memory 812 to CPU 810. A system bus 806 couples hard drive 814, CD/DVD ROM drive 816 and connection ports 808 to CPU 810. Multiple input devices may be provided, such as for example a mouse 820 and keyboard 822. Multiple output devices may also be provided, such as for example a video monitor 824 and a printer (not shown).

Computer system 800 may be a commercially available system, such as a desktop workstation unit provided by IBM, Dell Computers, Gateway, Apple, or other computer system provider. Computer system 800 may also be a networked computer system, wherein memory storage components such as hard drive 814, additional CPUs 810 and output devices such as printers are provided by physically separate computer systems commonly connected together in the network. Those skilled in the art will understand and appreciate that physical composition of components and component interconnections comprising computer system 800, and select a computer system 800 suitable for the establishing SSDO 100 and method 500.

When a computer system 800 is activated as the database 110 or client 114, preferably an operating system 826 will load into main memory 812 as part of the boot strap startup sequence and ready the computer system 800 for operation. At the simplest level, and in the most general sense, the tasks of an operating system fall into specific categories—process management, device management (including application and user interface management) and memory management.

In such a computer system 800 adapted to be the database 110, the CPU 810 is operable to adapt computer system 800 to perform one or more of the methods relating to the establishing and maintenance of the database 110 as discussed above. In such a computer system 800 adapted to be a client, the CPU 810 is operable to adapt computer system 800 to safeguard the digital object 102, by analyzing each digital asset to determine each unique identifier 106 and query the database 110 with the determined unique identifiers 106 to confirm validate the digital assets, confirm proper relationships as between digital assets 104, remove the impairer 108, and/or combinations thereof.

Those skilled in the art will understand that a computer-readable medium 828 on which is a computer program 830 for establishing the database 110, or adapting the system for behavior as a client 114 may be provided to the computer system 800. The form of the computer-readable medium 828 and language of the program 830 are understood to be appropriate for computer system 800. Utilizing the memory stores, such as for example one or more hard drives 814 and main memory 812, the operable CPU 810 will read the instructions provided by the computer program 830 and operate to perform as the database 110 or client 114 in SSDO 100 as described above.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall there between.

What is claimed is:

1. A method of safeguarding digital objects consisting of digital assets comprising:
receiving a subset of the digital assets, each digital asset of the digital object having a unique identifier embedded therein;
analyzing each received digital asset to determine each unique identifier; and
querying a database with each determined unique identifier to confirm a proper relationship as between at least a first received digital asset and a second digital asset, and validate or invalidate the subset of digital assets.

2. The method of claim 1, wherein the proper relationship is a distinctly related relationship.

3. The method of claim 2, wherein at least two distinctly related digital assets are country related digital assets.

4. The method of claim 1, wherein the second digital asset is a previously received digital asset.

5. The method of claim 1, wherein a user directed change to a digital asset results in a derivative digital asset, a unique identifier being embedded within the derivative digital asset, the unique identifier reported to the database.

6. The method of claim 1, wherein the unique identifier is robust.

7. The method of claim 6, wherein the robust nature of the identifier is sufficient to generally persist through events selected from the group consisting of digital asset: compression, truncation, transformation, corruption, conversion and/or combinations thereof.

8. The method of claim 1, wherein querying the database to validate each digital asset is permitted within a pre-set authorization window, a query performed after this window invalidating each digital asset.

9. The method of claim 1, wherein querying the database to validate each digital asset includes evaluating the integrity of each digital asset.

10. The method of claim 9, wherein the evaluation of integrity includes a checksum computation upon each digital asset.

11. The method of claim 1, wherein querying the database further comprises receiving related metadata regarding the digital asset as identified by the database.

12. The method of claim 11, wherein the metadata is received from the database.

13. The method of claim 11, wherein the metadata is received from at least one second remote file system.

14. The method of claim 11, wherein the metadata further identifies a relationship between derivative digital assets.

15. The method of claim 1, wherein a removable impairer is incorporated within at least one received digital asset, removal of the impairer dependent upon querying the database as an identified party authorized to use the received digital assets.

16. The method of claim 1, further including:
embedding a unique identifier in each digital asset;
entering each unique identifier in the database, the database further structured and arranged to correlate at least two digital assets as distinctly related;
selecting at least a subset of the digital assets for delivery to a third party; and
providing to the third party the selected subset of digital assets.

17. A method of safeguarding digital objects consisting of digital assets, comprising:
embedding a unique identifier in each digital asset;
entering each unique identifier in a database, the database further structured and arranged to correlate at least two digital assets as distinctly related, the database further including reference to related metadata regarding each identified digital asset, the metadata further identifying a relationship between derivative digital assets; and
applying a removable impairer to at least one digital asset, the impairer structured and arranged for removal upon proper authentication by an authorized party.

18. The method of claim 17, wherein the unique identifier is robust.

19. The method of claim 18, wherein the robust nature of the identifier is sufficient to generally persist through events selected from the group consisting of digital asset: compression, truncation, transformation, corruption, conversion and/or combinations thereof.

20. The method of claim 17, wherein at least two distinctly related digital assets are country related digital assets.

21. The method of claim 17, wherein a user directed change to a digital asset results in a derivative digital asset, a unique identifier being embedded within the derivative digital asset, the unique identifier reported to the database.

22. The method of claim 17, wherein the metadata is received from the database.

23. The method of claim 17, wherein the metadata is received from at least one second remote file system.

24. The method of claim 17, further including:
selecting at least a subset of the digital assets for delivery to a third party;
receiving, by the third party, the selected subset of digital assets;
analyzing each digital asset to determine the unique identifier embedded therein;
querying the database with the determined unique identifiers to validate each digital asset, the validating further including confirming receipt of distinctly related digital assets; and
in response to proper validation, removing the removable impairer from it's associated digital asset.

25. The method of claim 24, wherein removal of the impairer is dependent upon querying the database as an identified party authorized to use the received digital assets.

26. The method of claim 24, wherein querying the database further comprises receiving related metadata regarding the digital asset as identified by the database.

27. The method of claim 26, wherein the metadata is received from the database.

28. The method of claim 26, wherein the metadata is received from at least one second remote file system.

29. A method of safeguarding digital objects consisting of digital assets, comprising:
embedding a unique identifier in each digital asset;
entering each unique identifier in a database, the database further structured and arranged to correlate at least two digital assets as distinctly related;
selecting at least a subset of the digital assets for delivery to a third party;
receiving, by the third party, the selected subset of digital assets;
analyzing each digital asset to determine the unique identifier embedded therein; and
querying the database with the determined unique identifiers to validate each digital asset, the validating further including confirming receipt of distinctly related digital assets.

30. The method of claim 29, further including applying a removable impairer to at least one digital asset.

31. The method of claim 30, wherein removal of the impairer is dependent upon querying the database as an identified party authorized to use the received digital assets

32. The method of claim 29, wherein at least two distinctly related digital assets are country related digital assets.

33. The method of claim 29, wherein the unique identifier is robust.

34. The method of claim 33, wherein the robust nature of the identifier is sufficient to generally persist through events selected from the group consisting of digital asset: compression, truncation, transformation, corruption, conversion and/or combinations thereof.

35. The method of claim 29, wherein querying the database further comprises receiving related metadata regarding the digital asset as identified by the database.

36. The method of claim 35, wherein the metadata is received from the database.

37. The method of claim 35, wherein the metadata is received from at least one second remote file system.

38. The method of claim 35, wherein the metadata further identifies a relationship between derivative digital assets.

39. The method of claim 29, wherein querying the database to validate each digital asset is permitted within a pre-set authorization window, a query performed after this window invalidating each digital asset.

40. The method of claim 29, further including recording to the database a record of each query.

41. The method of claim 29, wherein a user directed change to a digital asset results in a derivative digital asset, a unique identifier being embedded within the derivative digital asset, the unique identifier reported to the database.

42. A system of safeguarding digital objects consisting of digital assets, comprising:
a unique identifier in each digital asset;
a database with record of each unique identifier, the database further structured and arranged to correlate at least two digital assets as distinctly related; and
a client in communication with the database, the client adapted to:
receive a subset of digital assets;
analyze each digital asset to determine the unique identifier embedded therein;
query the database with the determined unique identifier to validate each digital asset, the validation further including confirmation of distinctly related digital assets received.

43. The system of claim 42, wherein the client comprises:
at least one processing unit;
at least one memory storage device coupled to the processing unit;
an input device coupled to the processing unit;
an output device coupled to the processing unit;
the processing unit being operative to adapt the client to safeguard the digital object by:
analyzing each digital asset to determine each unique identifier; and
querying a database with the determined unique identifiers to confirm a proper relationship as between the received digital assets.

44. The system of claim 42, wherein the unique identifier is robust.

45. The system of claim 44, wherein the robust nature of the identifier is sufficient to generally persist through events selected from the group consisting of digital asset: compression, truncation, transformation, corruption, conversion and/or combinations thereof.

46. The system of claim 42, further including metadata that is disposed separately from each digital asset, the unique identifier further identifying the associated metadata.

47. The method of claim 46, wherein the metadata further identifies a relationship between derivative digital assets.
